(19) United States
(12) Patent Application Publication
(10) Pub. No.: US 2013/0295488 A1
(43) Pub. Date: Nov. 7, 2013

(54) POLYMER ELECTROLYTE MEMBRANE, METHOD FOR PRODUCING THE SAME, MEMBRANE-ELECTRODE ASSEMBLY USING THE SAME, AND FUEL CELL USING THE SAME

(71) Applicants: NITTO DENKO CORPORATION, Osaka (JP); JAPAN ATOMIC ENERGY AGENCY, Ibaraki (JP)

(72) Inventors: Yutaka KISHII, Osaka (JP); Hideyuki EMORI, Osaka (JP); Hiroyuki NISHII, Osaka (JP); Shin HASEGAWA, Gunma (JP); Shin-ichi SAWADA, Gunma (JP); Yasunari MAEKAWA, Gunma (JP)

(73) Assignees: JAPAN ATOMIC ENERGY AGENCY, Ibaraki (JP); NITTO DENKO CORPORATION, Osaka (JP)

(21) Appl. No.: 13/875,775

(22) Filed: May 2, 2013

(30) Foreign Application Priority Data
May 7, 2012 (JP) 2012-105857

(51) Int. Cl. H01M 8/10

(52) U.S. Cl. CPC H01M 8/102; H01M 8/1069
USPC 429/493; 429/492; 429/535

(57) ABSTRACT

Provided are a polymer electrolyte membrane exhibiting a relatively high ion conductivity, and a method for producing the polymer electrolyte membrane.

The polymer electrolyte membrane of the present invention is an ion-conducting polymer electrolyte membrane including a polymer. The polymer includes a hydrophobic main chain and side chains bonded to the main chain. Each of the side chains includes a hydrophobic main chain portion and a plurality of side chain portions bonded to the main chain portion. Each of the side chain portions includes a hydrophobic first portion bonded to the main chain portion, and a second portion bonded to the first portion. The second portion includes an ion-conducting group.

### BACKGROUND OF THE INVENTION

1. Field of the Invention

The present invention relates to polymer electrolyte membranes, methods for producing the polymer electrolyte membranes, membrane-electrode assemblies using the polymer electrolyte membranes, and fuel cells using the polymer electrolyte membranes.

2. Description of Related Art

Polymer electrolyte membranes have conventionally been used for polymer electrolyte fuel cells (PEFC), alkaline electrolysis, air-humidifying modules, etc. Among these uses and devices, polymer electrolyte fuel cells have recently been attracting particular attention.

In a polymer electrolyte fuel cell, an electrolyte membrane functions as an electrolyte for conducting protons, and also functions as a separating membrane for preventing direct mixing of a fuel (hydrogen or methanol) and oxygen. Such an electrolyte membrane is required to have high ion⁻exchange capacity, high proton conductivity, high electrochemical stability, low electrical resistance, high physical strength, and barrier properties against fuel gases (such as hydrogen gas and oxygen gas).

Conventionally, polymers containing sulfonic acid group or phosphonic acid group have been preferentially used as a constituent polymer of an electrolyte membrane (JP H6(1994)-93114 A). For example, perfluoroalkyl ether sulfonic acid polymers (PFSA polymers), as typified by Nafion (registered trademark) of E.I. du Pont de Nemours and Company, have been used. In addition, there is also known a polymer obtained by graft-polymerization of a polymer that is a base material with a monomer such as styrene, and by the subsequent sulfonation of the resultant graft chains (JP 2004-59752 A). Among electrolyte membranes formed of these polymers, an electrolyte membrane including a fluorinated polymer as a base material has the advantage of excellent chemical stability.

In recent years, block copolymerization using a living radical polymerization technique has been attracting attention, and atom-transfer radical polymerization has been attracting particular attention. WO 2006/085695 discloses a method in which methyl methacrylate is copolymerized with the Cl moiety of vinylbenzyl chloride of a copolymer that is composed of styrene and vinylbenzyl chloride and that has a narrow molecular weight distribution. However, WO 2006/085695 does not describe any example of fabrication of an electrolyte membrane including an ion-conducting group.

In addition, another method for producing an electrolyte membrane is disclosed in “Synthesis of Proton⁻Conducting Membranes by the Utilization of Preirradiation Grafting and Atom Transfer Radical Polymerization Techniques”, Savante Holmberg et al., J. Polym. Sci., Part A, Polym. Chem., 2002; 40: 591-600. In this method, polyvinylidene fluoride is graft-polymerized with vinylbenzyl chloride first, and then styrene is added to the Cl moiety of vinylbenzyl chloride, followed by sulfonation. That is, in a polymer synthesized by the method disclosed in this document, side chains bonded to polyvinylidene fluoride are each composed of a hydrophobic main chain portion and a hydrophilic portion bonded directly to the main chain portion. The document discloses that the membrane of the document has a slightly lower proton conductivity than a membrane produced by introducing styrene directly without use of vinylbenzyl chloride, and then performing sulfonation.

That is, electrolyte membranes produced by block copolymerization using the living radical polymerization technique cannot necessarily be provided with improved properties such as high ion conductivity.

### SUMMARY OF THE INVENTION

In view of such circumstances, one object of the present invention is to provide an electrolyte membrane exhibiting a relatively high ion conductivity, and a method for producing the electrolyte membrane.

In order to attain the object, the present invention provides a polymer electrolyte membrane. The polymer electrolyte membrane is an ion-conducting polymer electrolyte membrane including a polymer. The polymer includes a hydrophobic main chain and side chains bonded to the main chain. Each of the side chain includes a hydrophobic main chain portion and a plurality of side chain portions bonded to the main chain portion. Each of the side chain portions includes a hydrophobic first portion bonded to the main chain portion, and a second portion bonded to the first portion. The second portion includes an ion-conducting group.

In addition, the present invention provides a method for producing a polymer electrolyte membrane. The method is intended to produce an ion-conducting polymer electrolyte membrane including a polymer. The method includes the steps of (i) adding, to a hydrophobic chain polymer, side chains each including a hydrophobic main chain portion and a hydrophobic first portion bonded to the main chain portion; and (ii) polymerizing a monomer containing at least one selected from an ion-exchange group and an ion-exchange group precursor at a terminal of the hydrophobic first portion, so as to form a chain structure composed of the first portion and a second portion formed of the monomer.

With the present invention, an electrolyte membrane exhibiting a relatively high ion conductivity can be obtained.

### BRIEF DESCRIPTION OF THE DRAWING

FIG. 1 is a diagram schematically showing the structure of a polymer used in an electrolyte membrane of the present invention.

### DETAILED DESCRIPTION OF THE INVENTION

Hereinafter, an embodiment of the present invention will be described. In the following description, the embodiment of the present invention will be described by using examples. However, the present invention is not limited to the examples described below. Although specific numerical values and specific materials are mentioned as examples in the following description, other numerical values and other materials may be applied as long as the effect of the present invention is obtained. Furthermore, the materials described below may be used singly, or two or more thereof may be used in combination, unless otherwise specified.

### Electrolyte Membrane

An electrolyte membrane of the present invention (solid polymer electrolyte membrane) is an ion-conducting electrolyte membrane including a polymer. Hereinafter, the polymer may be referred to as “polymer (P)”. A preferred example of the electrolyte membrane of the present invention is formed only of the polymer (P) or is formed substantially only of the polymer (P). The electrolyte membrane may contain other substances than the polymer (P) as long as the effect of the present invention is obtained. However, the proportion of the polymer (P) in the electrolyte membrane of the present invention ranges from 50 wt % to 100 wt %, and is generally 80 wt % or more, 90 wt % or more, 95 wt % or more, or 98 wt % or more.

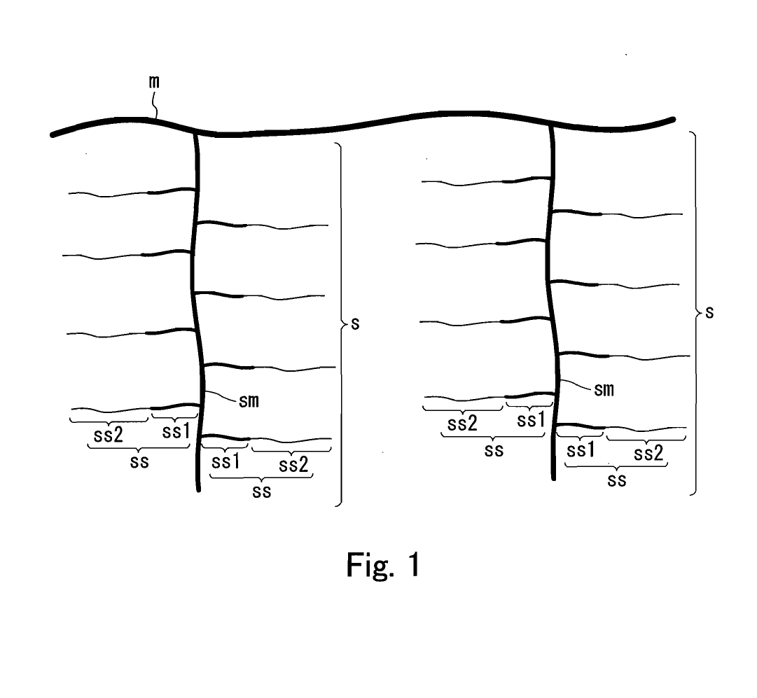

The polymer (P) includes a hydrophobic main chain and a plurality of side chains bonded to the main chain. Hereinafter, the main chain may be referred to as “main chain (m)”, and the side chain may be referred to as “side chain (s)”. Each side chain (s) includes a hydrophobic main chain portion (sm) and a plurality of side chain portions (ss) bonded to the main chain portion (sm). Each side chain portion (ss) includes a hydrophobic first portion (ss1) bonded to the main chain portion (sm), and a hydrophilic second portion (ss2) bonded to the first portion (ss1). The second portion (ss2) includes an ion-conducting group. The other portions than the second portion (ss2) include no ion-conducting group. An example of the structure of the polymer (P) is schematically shown in FIG. 1.

Examples of the ion-conducting group (functional group) included in the second portion (ss2) include cation-exchange groups (proton-conducting groups in another respect) and anion-exchange groups. Examples of the cation-exchange groups include commonly-known cation-exchange groups such as sulfonic acid group, phosphoric acid group, carboxylic acid group, and sulfonyl imide group. Examples of the anion-exchange groups include commonly-known anion-exchange groups such as hydroxyl group and halogen group. Among these, sulfonic acid group is preferred in that sulfonic acid group is strongly acidic, and exhibits good proton conductivity.

Among the constitutional units of the side chain (s), the constitutional units of the main chain portion (sm) and the constitutional units of the first portion (ss1) are hydrophobic constitutional units. By contrast, among the constitutional units of the side chain (s), the constitutional units of the second portion (ss2) are hydrophilic constitutional units. In the side chain (s), the value of (the number of moles of the hydrophobic constitutional units)/(the number of moles of the hydrophilic constitutional units) is preferably in a range of 0.05 to 0.5.

As the hydrophobic polymer that constitutes the main chain (m), aromatic hydrocarbon polymers, olefin polymers, and fluorinated olefin polymers are preferred in view of chemical stability, mechanical strength, and the like. Examples of these polymers are listed below.

Examples of the aromatic hydrocarbon polymers include polyethylene terephthalate, polybutylene terephthalate, polytrimethylene terephthalate, polyethylene naphthalate, polybutylene naphthalate, polyether ether ketone, polyether ketone, polysulfone, polyethersulfone, polyphenylene sulfide, polyarylate, polyetherimide, polyamide imide, and polyimide (for example, thermoplastic polyimide). In addition, a mixture of two or more thereof may be used, or a copolymer produced from a plurality of monomers used in synthesis of these polymers may be used.

Examples of the olefin polymers include polyethylene (such as low-density polyethylene, high-density polyethylene, and ultrahigh molecular weight polyethylene), polypropylene, polybutene, and polymethylpentene. In addition, a mixture of two or more thereof may be used, or a copolymer produced from a plurality of monomers used in synthesis of these polymers may be used.

Examples of the fluorinated polymers include polyvinylidene fluoride (PVDF), ethylene-tetrafluoroethylene copolymer, tetrafluoroethylene-hexafluoropropylene copolymer, polytetrafluoroethylene, tetrafluoroethylene-perfluoroalkyl vinyl ether copolymer, polychlorotrifluoroethylene, tetrafluoroethylene-hexafluoropropylene-vinylidene fluoride copolymer, and mixtures thereof.

In a preferred example, the main chain (m) includes at least one selected from the group consisting of polyvinylidene fluoride, ethylene-tetrafluoroethylene copolymer, vinylidene fluoride-hexafluoropropylene copolymer, polypropylene, polyethylene, polyether ether ketone, polyimide, polyamide imide, and polyetherimide. The polymer (P) including such a main chain (m) is easily soluble in a solvent or is easily melted, and thus allows easy film formation. Among the polymers listed above, fluorinated polymers such as polyvinylidene fluoride and ethylene-tetrafluoroethylene copolymer, polypropylene, and polyethylene are particularly preferred from the standpoint of chemical stability and cost.

The side chain (s) is generally formed by two-step polymerization reaction. The structure of the side chain (s) can be varied depending on monomers used for polymerization. The structure of the side chain (s) will be described later.

### Membrane-Electrode Assembly and Fuel Cell

A membrane-electrode assembly of the present invention is a membrane-electrode assembly for a fuel cell, and includes the polymer electrolyte membrane of the present invention. The other components than the electrolyte membrane are not particularly limited, and, for example, a commonly⁻known configuration can be applied.

A fuel cell of the present invention is a polymer electrolyte fuel cell including a membrane-electrode assembly, and the membrane-electrode assembly includes the polymer electrolyte membrane of the present invention. The other components than the polymer electrolyte membrane are not particularly limited, and, for example, a commonly-known configuration of polymer electrolyte fuel cells can be applied.

### Method for Producing Electrolyte Membrane

Hereinafter, a method of the present invention for producing an electrolyte membrane (polymer electrolyte membrane) will be described. With this production method, the electrolyte membrane of the present invention can be produced. The matters described for the electrolyte membrane of the present invention also apply to the production method of the present invention, and therefore redundant descriptions are omitted. In addition, the matters described for the production method of the present invention apply to the electrolyte membrane of the present invention.

The production method of the present invention is a method for producing an ion-conducting electrolyte membrane including a polymer. This production method includes the steps (i) and (ii) described below. The production method of the present invention may include other steps in addition to the steps (i) and (ii).

In the step (i), side chains each including a hydrophobic main chain portion and a hydrophobic first portion bonded to the main chain portion are added to a hydrophobic chain polymer.

Any of the polymers listed as examples of the main chain (m) can be used as the hydrophobic chain polymer. This polymer may be in the form of particles or a film.

The hydrophobic main chain portion included in the side chain added in the step (i) corresponds to the hydrophobic main chain portion (sm) described above. Hereinafter, the hydrophobic first portion included in the side chain added in the step (i) may be referred to as “first portion (ss1′)”. The first portion (ss1′) corresponds to the first portion (ss1) described above.

The side chain added in the step (i) can be formed by polymerizing a monomer with the main chain (m) using a commonly-known method. In a preferred example, the side chain is added by graft polymerization (e.g., radiation graft polymerization).

Examples of the monomer (hereinafter, may be referred to as “monomer (M1)”) used in the step (i) include monomers containing a carbon-carbon unsaturated bond (e.g., a carbon-carbon double bond such as vinyl group), and a specific functional group. The specific functional group is contained in the first portion (ss1'), and is typically present at the terminal of the first portion (ss1′). This functional group can be a functional group for bonding to the second portion (ss2) described above. Examples of such a functional group include halogen group (chloro group, bromo group, and iodine group). Specific examples of the monomer (M1) include vinylbenzyl chloride, chlorostyrene, bromobutylstyrene, chloroprene, and allyl chloride.

In the step (ii), a monomer containing at least one selected from an ion-exchange group and an ion-exchange group precursor is polymerized at the terminal of the hydrophobic first portion (ss1′) so as to form a chain structure composed of the first portion (ss1) and a second portion formed of the monomer.

Hereinafter, the monomer used in the step (ii) may be referred to as “monomer (M2)”. In the case where the monomer (M2) contains an ion-exchange group, the second portion formed in the step (ii) corresponds to the second portion (ss2) described above. In the case where the monomer (M2) contains an ion-exchange group precursor, the second portion formed in the step (ii) can be transformed into the second portion (ss2) described above by converting the ion-exchange group precursor into an ion-exchange group. Hereinafter, the second portion may be referred to as “second portion (ss2′)”. The chain structure formed in the step (ii), i.e., the chain structure composed of the first portion (ss1) and the second portion (ss2′), can be transformed into the side chain portion (ss) described above by converting the ion-exchange group precursor into the ion-exchange group.

Examples of the monomer (M2) include monomers containing a carbon-carbon unsaturated bond (e.g., a carbon-carbon double bond such as vinyl group), and at least one selected from an ion-exchange group and an ion-exchange group precursor. Examples of the ion-exchange group include the examples mentioned above. In addition, examples of the ion-exchange group precursor include ion-exchange group derivatives, and examples of the ion-exchange group derivatives include salts and esters of ion-exchange groups. Among those, esters of ion-exchange groups are preferred. A preferred example of the monomer (M2) contains a carbon-carbon double bond (e.g., vinyl group) and an ester of sulfonic acid group.

From another standpoint, the monomer (M2) is a monomer that contains vinyl group and in which part of hydrogen bonded to the vinyl group is substituted with another atom or a functional group. One monomer or a mixture of a plurality of monomers may be used as the monomer (M2). An example of the monomer (M2) is represented by the formula H2C═CXR. In this formula, X is a hydrogen atom, a fluorine atom, or a hydrocarbon group. R includes a sulfonic acid group precursor that can easily be converted into sulfonic acid group by a process such as hydrolysis and ion exchange. Examples of the sulfonic acid group precursor include esters and salts of sulfonic acid group, and esters of sulfonic acid group are preferred. Examples of esters of sulfonic acid group include sulfonic acid alkyl esters and sulfonic acid phenyl esters, and specific examples include methyl esters, ethyl esters, propyl esters, butyl esters, cyclohexyl esters, and phenyl esters. Examples of constituent ions of salts of sulfonic acid group include proton, and ions of alkali metals such as lithium, sodium, and potassium. In addition, the monomer (M2) may be a styrene derivative such as a styrene sulfonyl fluoride or may be an allylsulfonic acid derivative. A preferred example of the monomer (M2) is a styrenesulfonic acid ester, and is, for example, a styrenesulfonic acid alkyl ester containing one of the aforementioned esters of sulfonic acid group.

The polymerization of the monomer (M2) is preferably carried out by living radical polymerization. The living radical polymerization can be carried out in accordance with commonly-known techniques. For example, a method using 2,2,6,6-tetramethylpiperidine-1-oxyl radical (TEMPO radical), an atom-transfer radical polymerization method (ATRP method), or a method using a chain transfer agent (RAFT method), can be applied.

In the case where the monomer (M2) contains an ion-exchange group precursor, the production method of the present invention may further include a step In the case where the monomer (M2) contains an ion-exchange group precursor and does not contain any ion⁻exchange group, the production method of the present invention includes the step (iii). In the step the ion-exchange group precursor contained in the second portion (ss2′) is converted into an ion-exchange group. The step (iii) can be carried out by a commonly-known method in accordance with the type of the ion-exchange group precursor. For example, in the case where the ion-exchange group precursor is an ester of an ion-exchange group, the ion-exchange group precursor can be converted into the ion-exchange group by hydrolysis. In addition, in the case where the ion-exchange group precursor is a salt of an ion-exchange group, the ion-exchange group precursor can be converted into a proton-conducting group (cation-exchange group) by substituting a cation of the salt with proton.

In the manner as described above, the polymer (P) which is a component of the electrolyte membrane can be obtained. In the case where the polymer (P) used in the step (i) is in the form of a film, a polymer electrolyte membrane can be obtained through the step (i) and the step (ii) (and the step (iii) as necessary). In the case where the chain polymer used in the step (i) is in the form of particles, a step of forming a film using the polymer (P) is performed after the step (i). This film-forming step may be performed at any stage after the step (i). The film formation can be performed by a commonly⁻known casting film formation method.

An example of the polymer (P) has the following structure.

(1) The main chain (m) is formed of polyvinylidene fluoride.

(2) The hydrophobic main chain portion (sm) of the side chain (s) is formed by polymerization of vinyl group.

(3) The hydrophobic first portion (ss1) of the side chain portion (ss) of the side chain (s) is p-phenylene group (—C6H₄−).

(4) The hydrophilic second portion (ss2) of the side chain portion (ss) of the side chain (s) is poly(styrenesulfonic acid).

(5) The value of (the number of moles of the hydrophobic constitutional units)/(the number of moles of the hydrophilic constitutional units) in the side chain (s) is in the range specified above.

### EXAMPLES

Hereinafter, examples of the present invention will be described. In examples described below, polymer electrolyte membranes were fabricated, and their physical properties were measured and evaluated. The methods of measurement and evaluation will be described below.

(1) Graft Ratio

A graft ratio in radiation graft polymerization (first graft ratio), and a graft ratio in living radical polymerization (second graft ratio) were calculated by the following formulae.

First graft ratio (%)=((Weight of membrane after radiation graft polymerization)−(Weight of membrane before radiation graft polymerization))×100/ (Weight of membrane before radiation graft polymerization)

Second graft ratio (%)=((Weight of membrane after living radical polymerization)−(Weight of membrane before living radical polymerization))×100/(Weight of membrane before living radical polymerization)

(2) Ion-exchange Capacity (IEC)

First, the electrolyte membrane was thoroughly dried, and then weighed.

Next, the electrolyte membrane was immersed in a 3 mol/L sodium chloride aqueous solution at 60° C. for more than 12 hours to cause a reaction. That is, protons of sulfonic acid groups were substituted with sodium ions. Next, the reaction solution was cooled to a room temperature, and the electrolyte membrane was then washed with ion-exchange water. Subsequently, protons contained in the reaction solution and in the wash solution were titrated with a 0.05 N sodium hydroxide aqueous solution, and the ion-exchange capacity (IEC) was calculated based on the formula provided below. A potentiometric automatic titrator (AT-510 manufactured by Kyoto Electronics Manufacturing Co., Ltd.) was used for the titration.

Ion-exchange capacity (mmol/g)=((Titer (L))×(Concentration of sodium chloride aqueous solution (mol/L))×1000)/(Dry weight of electrolyte membrane(g))

(3) Proton Conductivity

The proton conductivity of the electrolyte membrane was measured in a thermo-hygrostat set at a constant temperature and humidity of 80° C. and 60% RH

(RH: relative humidity). Specifically, the measurement was carried out in accordance with the proton conductivity measurement method specified by Fuel Cell Commercialization Conference of Japan (FCCJ).

The methods for fabricating the electrolyte membranes of Example and Comparative Examples will be described below.

### Example 1

First, in a glass tube having been subjected to argon replacement, a membrane formed of polyvinylidene fluoride (PVDF) was irradiated with a γ-ray by cobalt 60 at an irradiation dose of 15 kGy. Next, 35 g of vinylbenzyl chloride (VBC, manufactured by AGC Seimi Chemical Co., Ltd.), and 35 g of dioxane were put into the glass tube. The vinylbenzyl chloride and dioxane were used after being subjected to sufficient argon replacement. Next, the glass tube was sealed, and left at 60° C. for 1 hour to allow polymerization reaction (graft polymerization) to proceed. Thereafter, the membrane was washed three times with acetone of 50° C. The membrane obtained was vacuum-dried at 40° C. The graft ratio (first graft ratio) of the membrane obtained was 16%.

Next, a mixed solution of N,N,N′,N″,N″-pentamethyldiethylenetriamine (PMDETA), 20 _{g} of dioxane, and 20 g of ethyl styrenesulfonate (EtSS, manufactured by Tosoh Corporation), was put into a container. PMDETA was added in such an amount that the molar ratio of PMDETA to vinylbenzyl chloride (VBC) introduced in the membrane was 2.5. This mixed solution was sufficiently bubbled with nitrogen, the membrane (about 0.1 g) having undergone the first grafting was placed in the mixed solution, and the temperature of the mixed solution was increased to 80° C. while the nitrogen bubbling was continued. Thereafter, cuprous bromide (CuBr) was put into the container in such an amount that the molar ratio of cuprous bromide to VBC was 2.5. The container was then sealed, and polymerization was carried out for 22 hours at a constant temperature of 80° C. In this manner, living radical polymerization was carried out. The membrane obtained was washed with acetone, and then vacuum-dried at 40° C. The graft ratio (second graft ratio) of the membrane obtained was 133%.

Thereafter, the membrane was treated under reflux of a saturated aqueous solution of octanol, and thus the sulfonic acid ester was deesterified. Next, the treated membrane was vacuum-dried at 40° C. The electrolyte membrane of Example 1 was thus fabricated.

### Comparative Example 1

First, in a glass tube having been subjected to argon replacement, a membrane formed of PVDF was irradiated with a γ-ray by cobalt 60 at an irradiation dose of 15 kGy. Next, 11.5 g of ethyl styrenesulfonate (EtSS) and 13.5 g of toluene that had been subjected to sufficient argon replacement were put into the glass tube. Next, the glass tube was sealed, and left at 70° C. for 2 hours to allow polymerization reaction (graft polymerization) to proceed. Thereafter, the membrane was washed three times with acetone of 50° C. The membrane obtained was vacuum-dried at 40° C. The graft ratio (first graft ratio) of the membrane obtained was 121%.

Next, similar to Example 1, the membrane was subjected to hydrolysis treatment using 1-octanol, and thus the sulfonic acid ester was deesterified. Next, the treated membrane was vacuum-dried. The electrolyte membrane of Comparative Example 1 was thus fabricated.

### Comparative Example 2

First, in a glass tube having been subjected to argon replacement, a membrane formed of PVDF was irradiated with a γ-ray by cobalt 60 at an irradiation dose of 15 kGy. Next, 35 g of vinylbenzyl chloride (VBC manufactured by AGC Seimi Chemical Co., Ltd.) and 35 g of dioxane that had been subjected to sufficient argon replacement were put into the glass tube. Next, the glass tube was sealed, and left at 60° C. for 1 hour to allow polymerization reaction (graft polymerization) to proceed. Thereafter, the membrane was washed three times with acetone of 50° C. The membrane obtained was vacuum-dried at 40° C. The graft ratio (first graft ratio) of the membrane obtained was 16%.

Next, a mixed solution of 2,2′-bipyridyl (BPY) and 10 g of styrene was put into a container. BPY was added in such an amount that the molar ratio of BPY to vinylbenzyl chloride (VBC) introduced by the preceding graft polymerization was 2. This mixed solution was sufficiently bubbled with nitrogen, the membrane (about 0.1 g) having undergone the first grafting was placed in the mixed solution, and the temperature of the mixed solution was increased to 120° C. while the nitrogen bubbling was continued. Thereafter, cuprous bromide (CuBr) was put into the container in such an amount that the molar ratio of cuprous bromide to VBC was 1. The container was then sealed, and polymerization was carried out for 22 hours at a constant temperature of 120° C. In this manner, living radical polymerization was carried out. The membrane obtained was washed with acetone, and then vacuum-dried at 40° C. The graft ratio (second graft ratio) of the membrane obtained was 33%.

The membrane thus obtained was immersed in a methylene chloride solution of chlorosulfonic acid (concentration: 0.2 mol/L, temperature: 60° C.) for 12 hours, and thereby sulfonic acid groups were added to the graft chains. Next, the membrane was washed with ethanol and water, and was vacuum-dried at 60° C. The electrolyte membrane of Comparative Example 2 was thus fabricated.

The results of evaluation of the electrolyte membranes of Example and Comparative Examples are shown in Table 1.

TABLE 1

| | Ion exchange capacity | Proton conductivity |
|---|---|---|
| | (mmol/g) | (S/cm) |
| Example 1 | 2.7 | 0.077 |
| Comparative Example 1 | 2.7 | 0.032 |
| Comparative Example 2 | 2.3 | 0.035 |

As shown in Table 1, the ion-exchange capacity of Example 1 was equal to that of Comparative Example 1, while the proton conductivity of Example 1 was more than twice that of Comparative Example 1.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

The present invention is applicable to electrolyte membranes, membrane-electrode assemblies of fuel cells, and fuel cells.

What is claimed is:

1. An ion-conducting polymer electrolyte membrane comprising a polymer, wherein
the polymer comprises a hydrophobic main chain and side chains bonded to the main chain,
each of the side chains comprises a hydrophobic main chain portion and a plurality of side chain portions bonded to the main chain portion,
each of the side chain portions comprises a hydrophobic first portion bonded to the main chain portion, and a second portion bonded to the first portion, and the second portion comprises an ion-conducting group.

2. The polymer electrolyte membrane according to claim 1, wherein the main chain comprises at least one selected from the group consisting of polyvinylidene fluoride, ethylene-tetrafluoroethylene copolymer, vinylidene fluoride-hexafluoropropylene copolymer, polypropylene, polyethylene, polyether ether ketone, polyimide, polyamide imide, and polyetherimide.

3. The polymer electrolyte membrane according to claim 1, wherein the hydrophobic main chain portion is at least one selected from the group consisting of polyethylene, polystyrene, polyvinylbenzyl, polybutadiene, and polyisoprene.

4. The polymer electrolyte membrane according to claim 1, wherein the second portion comprises at least one selected from the group consisting of polystyrenesulfonic acid, polyvinylsulfonic acid, polyisoprenesulfonic acid, and poly(acrylamido-t-butyl sulfonic acid).

5. A membrane-electrode assembly for a fuel cell, the membrane-electrode assembly comprising the polymer electrolyte membrane according to claim 1.

6. A polymer electrolyte fuel cell, comprising a membrane-electrode assembly comprising the polymer electrolyte membrane according to claim 1.

7. A method for producing an ion-conducting polymer electrolyte membrane comprising a polymer, the method comprising the steps of
(i) adding, to a hydrophobic chain polymer, side chains each comprising a hydrophobic main chain portion and a hydrophobic first portion bonded to the main chain portion; and
(ii) polymerizing a monomer containing at least one selected from an ion-exchange group and an ion-exchange group precursor at a terminal of the hydrophobic first portion, so as to form a chain structure composed of the first portion and a second portion formed of the monomer.

8. The method according to claim 7, further comprising a step of (iii) converting the ion-exchange group precursor into an ion-exchange group when the monomer contains the ion-exchange group precursor.

9. The method according to claim 7, wherein
the side chains are added by radiation graft polymerization in the step (i), and
the monomer is polymerized by atom-transfer radical polymerization in the step (ii).

10. The method according to claim 7, wherein the chain polymer is in the form of particles or a film.
